(19) United States
(12) Patent Application Publication
(10) Pub. No.: US 2026/0137590 A1
(43) Pub. Date: May 21, 2026

(54) ACUPUNCTURE DEVICE

(71) Applicant: The First Affiliated Hospital of Sun Yat-sen University, Guangzhou (CN)

(72) Inventors: peiqiang Su, GuangZhou (CN); mingbin Zhan, GuangZhou (CN); hengyu Liu, GuangZhou (CN); ricong Weng, GuangZhou (CN)

(21) Appl. No.: 19/295,903

(22) Filed: Aug. 11, 2025

(30) Foreign Application Priority Data
Aug. 12, 2024 (CN) 202411096726X

(51) Int. Cl. A61H 39/08

(52) U.S. Cl. CPC A61H 39/08; A61H 2201/0153; A61H 2201/0173; A61H 2201/12; A61H 2201/1207; A61H 2201/149

(57) ABSTRACT

The disclosure relates to a therapeutic device and discloses an acupuncture device which comprises the needle gun having the gun shell, the trigger, the firing assembly, and the triggering assembly. When the trigger is in the firing state, the transmission portion is disengaged from the power output of the transmission member, and the first spring is released from the compressed state to the natural state, thereby ejecting the firing rod disposed in the chute of the firing sleeve through the elastic force instantaneously released by the first spring. Consequently, the needle can be ejected from the needle outlet by the firing rod, thereby achieving acupuncture. After the firing is completed, the trigger can be rotated to engage the transmission portion with the power output of the transmission member, thereby placing the first spring in the compressed state, switching to the reset state, and awaiting the next firing action.

### CROSS REFERENCES TO PRIORITY APPLICATIONS

This application claims the benefit of the priority of Chinese Patent Application No. 202411096726.X filed on Aug. 12, 2024, the contents of which are incorporated herein by reference.

### TECHNICAL FIELD

This invention relates to a therapeutic device, more particularly to an acupuncture device.

### BACKGROUND OF THE INVENTION

A conventional therapeutic method in acupuncture involves inserting specialized needles into a patient's body at specific angles under the guidance of traditional Chinese medicine theory and stimulating specific areas of the body by acupuncture techniques such as twirling and lifting-thrusting, so as to achieve the goal of treating diseases.

By using the very thin needles, the manual twisting operation during the penetrating process of acupuncture treatment has a high level of operational difficulty and low penetration efficiency. Moreover, variations in operators' acupuncture skills may lead to inconsistent treatment outcomes, further reducing the acupuncture efficiency.

In order to increase the acupuncture efficiency and reduce the operational difficulty, acupuncture guns have been developed, which utilize firing mechanisms to instantaneously fire needles and rapidly propel the needles to penetrate the skin. They can eliminate the need for manual twisting operation to insert the needles and thus can increase the acupuncture efficiency. Furthermore, they can reduce the pain for the patient by rapid and accurate needle insertion.

Existing acupuncture guns typically comprise the firing drive mechanism and the firing reset mechanism that are separately provided. Users usually pull the trigger to actuate the needle and achieve insertion. After the insertion of the needle, due to the separately provided firing reset mechanism, users need to adjust their postures and change the way they grip the gun to use the firing reset mechanism to reset the device, thereby preparing for a next firing action. This significantly affects the acupuncture efficiency, making it difficult to achieve continuous firing. Hence, they are not easy to promote and use.

### SUMMARY OF THE INVENTION

The purpose of the present invention is to provide an acupuncture device, which is capable of improving the acupuncture efficiency and achieving continuous firing.

To achieve the above purpose, the present invention adopts the following technical solution: An acupuncture device, comprising:
a needle gun and a needle storage portion for storing needles, wherein the needle storage portion is assembled with the needle gun, wherein the needle gun further comprises: a gun shell and a firing assembly used for firing the needles in the needle storage portion outwards, wherein the firing assembly is assembled with the gun shell, wherein the firing assembly comprises:
an energy storage mechanism for forming an impact force on the current needle, a trigger mechanism for generating a force on the energy storage mechanism, and an energy-increasing mechanism for increasing the force of the energy storage mechanism, wherein both the energy storage mechanism and the energy-increasing mechanism are located inside the gun shell, wherein the trigger mechanism is in transmission connection with the energy-increasing mechanism, wherein the energy-increasing mechanism is movably connected to the energy storage mechanism, wherein when there is a need to fire the current needle, the force generated by the trigger mechanism is conducted to the energy storage mechanism, wherein at this point, under the limit of the energy-increasing mechanism, the motion of the energy storage mechanism is limited, wherein the trigger mechanism continues to make the energy storage mechanism store energy, and wherein after the energy storage mechanism is released, the energy of the energy storage mechanism is released, so that the current needle is fired outward from the needle storage portion.

In another preferred embodiment, the energy storage mechanism is a spring or an elastic member.

In another preferred embodiment, the needle gun comprises a gun shell, a trigger A, a firing assembly, and a trigger mechanism B;
the gun shell is provided with a shell-type needle outlet channel and a mounting cavity, and the shell-type needle outlet channel has one end extending through a front surface of the gun shell and another end in communication with the mounting cavity;
the firing assembly comprises a first spring which serving as the energy storage mechanism, as well as a firing bar and a firing sleeve which together constitute the energy-increasing mechanism, the firing sleeve is fixedly mounted on the gun shell and is provided with a sliding slot extending in a front-to-rear direction, the sliding slot is positioned directly behind the shell-type needle outlet channel, and the firing bar is slidably connected in the sliding slot of the firing sleeve;
the trigger A is provided on the gun shell; the trigger mechanism B is disposed in the mounting cavity and comprises a trigger member and a transmission mechanism; the trigger A is connected to a power input of the transmission mechanism; the trigger member comprises a push portion and a transmission portion connected with each other; the push portion is slidably connected in the sliding slot of the firing sleeve and is positioned behind the firing bar; the transmission portion is located outside the firing sleeve; the first spring is disposed in the sliding slot and positioned between the firing bar and the trigger member;
the transmission portion is connected with a power output of the transmission mechanism in a clutchable manner; and
the trigger A is switchable between a reset state and a firing state; in the reset state of the trigger A, the transmission portion and the power output of the transmission mechanism are clutched, and the first spring is in a compressed state; in the firing state of the trigger A, the transmission portion and the power output of the transmission mechanism are declutched, and the first spring is released from the compressed state to the natural state.

In another preferred embodiment, the transmission mechanism comprises a driving gear and a driving member;
the driving gear and the driving member are rotatably connected in the mounting cavity, the trigger is mounted on the drive gear, to drive the driving gear to rotate;
the driving member comprises a body that is disc-shaped, an meshed portion and a release portion are circumferentially arranged in sequence along an outer periphery of the body, the meshed portion is defined with gear teethes provided on an outer peripheral surface of the body, and the release portion is defined with a smooth surface provided on the outer peripheral surface of the body;
the transmission portion is provided with a rack extending in the front-to-rear direction,
the meshed portion is meshed with the drive gear, such that the trigger member is engaged with the transmission mechanism in such a case that the rack is engaged with the meshed portion, and the trigger member is disengaged from the transmission mechanism in such a case that the rack comes into contact with the release portion.

5. The acupuncture device according to claim 3, wherein the needle gun further comprises a locking assembly;
the locking assembly is disposed in the mounting cavity and arranged behind the firing sleeve at an interval, the locking assembly comprises a locking member and a second spring, and the locking member is connected to the gun shell via the second spring;
the trigger member is provided at a rear end with a locking position, and the locking member is cooperated and connected with the locking position in the reset state of the trigger.

In another preferred embodiment, the locking position is formed as a stop protruding downward and arranged at a rear end of the trigger member, and the stop has a front side surface that can engage a rear surface of the locking member to achieve cooperation and connection between the locking member and the stop, an upper end of the locking member has an inclined surface that gradually inclines upward from front to back..

In another preferred embodiment, further comprising an unlocking member mounted on the gun shell and connected to the locking member.

In another preferred embodiment, the return spring is connected between the trigger A and the gun shell, wherein, in the reset state of the trigger A, the return spring is in a natural state; and in the firing state of the trigger A, the return spring is in a compressed or stretched state.

In another preferred embodiment, the gun shell is provided with a guide slot, the trigger A has a guiding portion that is slidably disposed in the guide slot, and the return spring is positioned in the guide slot;
a restriction portion for cooperating with the firing bar to achieve position limitation is disposed in the firing sleeve.

In another preferred embodiment, the needle storage portion is a needle box, wherein the needle box is detachably connected to the interior of the gun shell, wherein the needle box is provided with a box-type needle outlet channel, and wherein the box-type needle outlet channel is located between the needle outlet and the firing assembly.

In another preferred embodiment, the energy-increasing mechanism comprises:
a rotating shaft, a clamping platform, a clamping block A and a first return spring, wherein the rotating shaft is fixed on an inner surface of the gun shell, wherein one end of the clamping platform is rotatably sleeved with the rotating shaft, wherein the other end of the clamping platform is movably abutted against a top block of the impact source mechanism, wherein the clamping block is integrally connected to the other end of the clamping platform, wherein two end surfaces of the first return spring respectively abut against the inner surface of the clamping platform and the gun shell, and wherein the clamping block A is clamped with the ejector pin portion of the impact source mechanism.

In another preferred embodiment, the trigger mechanism is defined as the trigger mechanism A, wherein the trigger mechanism A is provided with an ejector pin portion for impacting the current needle and an impact source mechanism, wherein the ejector pin portion is movably sleeved on a front end of the impact source mechanism, wherein the energy storage mechanism is located between the ejector pin portion and the impact source mechanism, wherein the energy-increasing mechanism is rotatably connected in the interior of the gun shell, wherein when firing the current needle, the impact source mechanism is propelled to move forwards, wherein the impact source mechanism further propels the ejector pin portion to move forwards until the ejector pin portion is clamped with the energy-increasing mechanism, wherein the impact source mechanism continues to push forwards, wherein at this point, the ejector pin portion is clamped and fixed to compress the energy storage mechanism, wherein when the impact source mechanism continues to push until abutting against the energy-increasing mechanism, wherein the energy-increasing mechanism rotates and releases the ejector pin portion, and wherein under the resilience action of the energy storage mechanism, the ejector pin portion pops out from the front end of the gun shell and impacts the current needle, so that the current needle is fired outwards from the needle storage portion.

In another preferred embodiment, the impact source mechanism is a mechanical impact source mechanism, wherein the mechanical impact source mechanism comprises:
an excitation push rod and a push rod portion used for resetting the excitation push rod, wherein the excitation push rod movably penetrates through the gun shell, wherein the excitation push rod movably abuts against the energy-increasing mechanism, wherein the excitation push rod movably abuts against the energy-increasing mechanism, wherein the push rod portion is fixedly connected to the interior of the gun shell, wherein one end of the push rod portion abuts against the excitation push rod, wherein the ejector pin portion is movably sleeved on a front end of the excitation push rod, wherein the energy storage mechanism is located between the ejector pin portion and the excitation push rod, wherein two end surfaces of the energy storage mechanism respectively abut against the ejector pin portion and the excitation push rod, wherein a front end of the ejector pin portion movably penetrates through the needle storage portion, and wherein the ejector pin portion is movably clamped with the energy-increasing mechanism.

In another preferred embodiment, the excitation push rod comprises:
a push rod main body, a first sleeve rod and a top block A for making the energy-increasing mechanism rotate, wherein the push rod main body movably penetrates through the gun shell, wherein the first sleeve rod is fixedly connected to a front end surface of the push rod main body, wherein the ejector pin portion is movably sleeved on an outer surface of the first sleeve rod, wherein the energy storage mechanism is sleeved on the outer surface of the first sleeve rod, wherein the top block A is connected to a front end of the push rod main body, and wherein the top block A movably abuts against the energy-increasing mechanism.

In another preferred embodiment, the push rod portion further comprises:
a second sleeve rod and a thrust spring, wherein the second sleeve rod is fixedly assembled inside the gun shell, wherein the thrust spring is sleeved on an outer surface of the second sleeve rod, wherein two ends of the thrust spring respectively abut against the push rod body and an inner wall of the gun shell, wherein when the current needle needs to be fired, the excitation push rod is propelled to move forward to compress the thrust spring, wherein after the firing is completed, the pushing force of the excitation push rod disappears, and wherein under the action of the resilience force of the thrust spring, the excitation push rod and the ejector pin portion are propelled to reset.

In another preferred embodiment, the impact source mechanism is an electrically driven impact source mechanism, wherein the electrically driven impact source mechanism comprises:
a connecting member for propelling the ejector pin portion and the energy storage mechanism to move back and forth, an electric drive portion for propelling the connecting member to move back and forth, and a third sleeve rod, wherein the connecting member, the electric drive portion and the third sleeve rod are all located inside the gun shell, wherein the connecting member movably abuts against the energy-increasing mechanism, wherein the third sleeve rod is fixedly connected to a front end surface of the connecting member, wherein the ejector pin portion is movably sleeved on a front end of the third sleeve rod, wherein the energy storage mechanism is sleeved on the third sleeve rod, wherein the energy storage mechanism is located between the ejector pin portion and the connecting member, wherein two end surfaces of the energy storage mechanism respectively abut against the ejector pin portion and the connecting member, wherein the front end of the ejector pin portion movably penetrates through the needle storage portion, and wherein the ejector pin portion is movably clamped with the energy-increasing mechanism.

In another preferred embodiment, the electrically driven impact source mechanism further comprises:
a guide rod, and an excitation button, wherein the guide rod and the excitation button are both located inside the gun shell, wherein the guide rod is fixedly connected to the interior of the gun shell, wherein the connecting member and the ejector pin portion are both movably sleeved on the guide rod, wherein the excitation button is electrically connected to the electric drive portion, wherein the connecting member comprises:
a connecting base, a mounting block, and a top block B for making the energy-increasing mechanism rotate, wherein the connecting base is fixedly connected to the mounting block, wherein the third sleeve rod is fixedly connected to a front end surface of the connecting base, wherein the connecting base is movably sleeved with the guide rod, wherein the mounting block is fixedly connected to the electric drive portion, wherein the top block B is integrally connected to a front end of the connecting base, wherein the top block B movably abuts against the energy-increasing mechanism, wherein the electric drive portion comprises:
a motor, a transmission belt and a pair of rotating wheels, wherein the motor, the transmission belt and the rotating wheels are all arranged inside the gun shell, wherein a shaft of the motor is in transmission connection with one of the rotating wheels, wherein the transmission belt is sleeved outside the two rotating wheels, and wherein the mounting block is fixedly connected to the transmission belt.

In another preferred embodiment, the ejector pin portion comprises: an ejector pin, a needle seat and a clamping block B, wherein the ejector pin is fixedly connected to a front end surface of the needle seat, wherein the clamping block B is integrally connected to a front end of the needle seat, and wherein the clamping block B is movably clamped with the energy-increasing mechanism.

In another preferred embodiment, the needle storage portion is a needle cylinder, wherein the needle cylinder is detachably assembled at the front end of the gun shell, wherein the needle cylinder comprises:
a main cylinder body, an inner cylinder body, an outer cylinder body, an end cover, a pressing plate and a toggle spring, wherein the inner cylinder body is located at a rear end of the main cylinder body, wherein the outer cylinder body is sleeved outside the main cylinder body and the inner cylinder body, wherein an annular needle slot for storing needles is formed between the outer cylinder body as well as the main cylinder body and the inner cylinder body, wherein a front end of the outer cylinder body abuts against a front end of the main cylinder body, wherein a rear end of the outer cylinder body is clamped with the end cover, wherein the pressing plate and the toggle spring are both assembled inside the inner cylinder body, wherein the pressing plate is in transmission connection with the toggle spring, wherein the pressing plate is further connected to the main cylinder body through a shaft, and a working end of the pressing plate abuts against the needle in the annular needle slot, and wherein the elastic force of the toggle spring allows the working end of the pressing plate to generate a pressing force, thereby making the needle rotate along the annular needle slot towards the position of a cylindrical needle outlet channel of the main cylinder body.

The acupuncture device comprises a needle gun and a needle storage portion for storing needles, wherein the needle storage portion is assembled with the needle gun; the needle gun further comprises a gun shell and a firing assembly used for firing the needles in the needle storage portion outwards, and the firing assembly is assembled with the gun shell; the firing assembly comprises an energy storage mechanism for forming an impact force on the current needle, a trigger mechanism for generating a force on the energy storage mechanism, and an energy-increasing mechanism for increasing the force of the energy storage mechanism; both the energy storage mechanism and the energy-increasing mechanism are located inside the gun shell, the trigger mechanism is in transmission connection with the energy-increasing mechanism, and the energy-increasing mechanism is movably connected to the energy storage mechanism; when there is a need to fire the current needle, the force generated by the trigger mechanism is conducted to the energy storage mechanism, and at this point, under the limit of the energy-increasing mechanism, the motion of the energy storage mechanism is limited, and the trigger mechanism continues to make the energy storage mechanism store energy; after the energy storage mechanism is released, the energy of the energy storage mechanism is released, so that the current needle is fired outward from the needle storage portion; the acupuncture device may switch between a reset state and a firing state by means of the firing assembly, thereby allowing an operator to perform reset and firing through the firing assembly; in this way, the acupuncture efficiency is enhanced, the continuous firing is facilitated, and the use is promoted.

### BRIEF DESCRIPTION OF DRAWINGS

The present invention is further described with reference to the drawings, but the contents in the drawings do not constitute any limitation on the present invention.

FIG. 1 is a schematic view which illustrates an internal structure of an acupuncture device in a to-be-fired state according to an embodiment of the disclosure;

FIG. 2 is a schematic view which illustrates an internal structure of an acupuncture device in a firing state according to an embodiment of the disclosure;

FIG. 3 is a schematic view which illustrates an internal structure of an acupuncture device in the first reset step according to an embodiment of the disclosure;

FIG. 4 is a schematic view which illustrates an internal structure of an acupuncture device in the second reset step according to an embodiment of the disclosure;

FIG. 5 is an enlarged schematic view of the A area of FIG. 1;

FIG. 6 is an enlarged schematic view of the B area of FIG. 1;

FIG. 7 is an enlarged schematic view of the C area of FIG. 1;

FIG. 8 is a schematic plan view of a driving member of an acupuncture device according to an embodiment of the disclosure;

FIG. 9 is a structural view illustrating a cooperation between a box body and an adjustment gear of an acupuncture device according to an embodiment of the disclosure.

FIG. 10 is a schematic diagram illustrating an exemplary structure when the needle gun and the needle storage portion of the acupuncture device are separated;

FIG. 11 is a schematic diagram illustrating another viewing angle of FIG. 10;

FIG. 12 is a schematic diagram illustrating an exemplary structure when the trigger mechanism in the needle gun is separated;

FIG. 13 is a schematic diagram illustrating an internal structure when the needle gun is in a ready-to-fire state;

FIG. 14 is a schematic diagram illustrating an exemplary structure when the trigger mechanism and the energy-increasing mechanism are in a ready-to-fire state;

FIG. 15 is a schematic diagram illustrating an internal structure when the needle gun is in a firing state;

FIG. 16 is a schematic diagram illustrating an exemplary structure when the trigger mechanism and the energy-increasing mechanism is in a firing state;

FIG. 17 is a schematic diagram illustrating an exemplary structure when the needle storage portion is separated;

FIG. 18 is a schematic diagram illustrating an exemplary structure of the needle storage portion;

FIG. 19 is a schematic diagram illustrating a sectional view along line A-A in FIG. 18;

FIG. 20 is a schematic diagram illustrating an exemplary structure of the needle gun in embodiment 3;

FIG. 21 is a schematic diagram illustrating an internal structure of the needle gun in embodiment 3;

FIG. 22 is a schematic diagram illustrating an exemplary structure when the trigger mechanism and the energy-increasing mechanism are in a ready-to-fire state;

FIG. 23 is a schematic diagram illustrating an internal structure of the needle gun in embodiment 4.

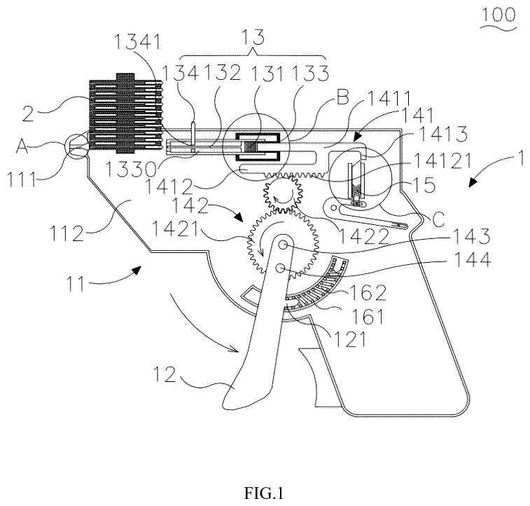

In FIGS. 1—23: 100—Acupuncture Device, 1—Needle Gun, 11—Gun Shell, 111—Shell-type Needle Outlet Channel, 1111—Outlet Portion, 1112—Alignment Portion, 112—Mounting Cavity, 12—Trigger A, 121—Guide Portion, 13—Firing Assembly, 132—Firing Bar, 1321—Firing Portion, 1322—Restriction Portion, 133—Firing Sleeve, 1330—Sliding Slot, 1331—Inner Sleeve, 13311—Inner Channel, 1332—Outer Sleeve, 13321—Sleeving Cavity, 13322—The First Opening, 13323—The Second Opening, 13324—Extension Portion, 134—Limiting Portion, 1341—Limiting Channel, 135—Trigger Mechanism A, 1351—Excitation Push rod, 13511—Push Rod Main Body, 13512—The First Sleeve Rod, 13513—Top Block A, 13514—Locking Member, 13521—The Second Sleeve Rod, 1353—Ejector Pin Portion, 13531—Ejector Pin, 13532—Needle Seat, 13533—Top Block B, 1355—Guide Rod, 1358—Connecting Member, 13581—Top Block B, 13582—Connecting Base, 13583—Mounting Block, 1359—Electric Drive Portion, 13591—Motor, 13592—Transmission Belt, 13593—Rotating Wheel, 13510—Excitation Button, 136—Energy—increasing Mechanism, 1361—Rotating Shaft, 1362—Clamping Platform, 1363—Clamping Block A, 1364—The First Return Spring, 137—Energy Storage Mechanism, 14—Trigger Mechanism B, 141—Trigger Member, 1411—Push Portion, 1412—Transmission Portion, 1413—Locking Position, 14121—Rack, 142—Transmission Mechanism, 1421—Driving Gear, 1422—Driving Member, 14221—Body, 14222—Meshed Portion, 14223—Release Portion, 143—The First Connecting Rod, 144—The Second Connecting Rod, 15—Locking Assembly, 151—Locking Member, 152—The Second Spring, 153—Unlocking Portion, 161—The Return Spring, 162—Guide Slot, 17—Trigger B, 18—Circuit Board, 19—Battery, 1010—Photoelectric Sensor, 1011—Detection Sheet, 1012—Locking Button, 1013—Counting Display Portion, 1014—The Third Sleeve Rod, 2—Needle Storage Portion, 21—Box Body, 211—Needle—storage cavities, 212—Adjustment Gear, 22—Needle Cylinder, 221—Main Cylinder body, 2211—Needle Outlet Pipe, 2212—Positioning Rod, 2213—Clamping Column, 222—Inner Cylinder Body, 223—Outer Cylinder Body, 224—End Cover, 2241—Clamping Member, 2242—Positioning Groove, 225—Pressing Plate, 226—Toggle Spring, 227—Cylindrical Needle Outlet Channel, 228—Clamping Hole, 3—Needle.

### DETAILED DESCRIPTION OF THE INVENTION

The technical solution of the present invention is further described with reference to the following embodiments. For ease of description, one end of the acupuncture device close to the user end during use is defined as a front end, and one end of the acupuncture device away from the user end is defined as a rear end.

### Embodiment 1

An acupuncture device, comprising: a needle gun and a needle storage portion for storing needles, wherein the needle storage portion is assembled with the needle gun, wherein the needle gun further comprises: a gun shell and a firing assembly used for firing the needles in the needle storage portion outwards, wherein the firing assembly is assembled with the gun shell, wherein the firing assembly comprises:
an energy storage mechanism for forming an impact force on the current needle, a trigger mechanism for generating a force on the energy storage mechanism, and an energy-increasing mechanism for increasing the force of the energy storage mechanism, wherein both the energy storage mechanism and the energy-increasing mechanism are located inside the gun shell, wherein the trigger mechanism is in transmission connection with the energy-increasing mechanism, wherein the energy-increasing mechanism is movably connected to the energy storage mechanism, wherein when there is a need to fire the current needle, the force generated by the trigger mechanism is conducted to the energy storage mechanism, wherein at this point, under the limit of the energy-increasing mechanism, the motion of the energy storage mechanism is limited, wherein the trigger mechanism continues to make the energy storage mechanism store energy, and wherein after the energy storage mechanism is released, the energy of the energy storage mechanism is released, so that the current needle is fired outward from the needle storage portion. The energy storage mechanism is a spring or an elastic member.

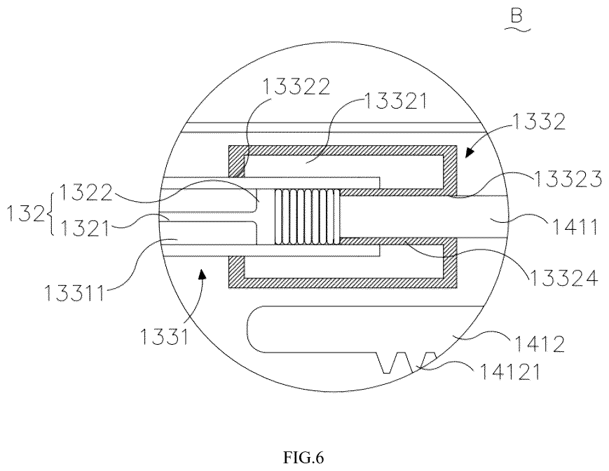

Referring to FIGS. 1-9, an acupuncture device 100 according to the embodiment of the disclosure comprises a needle gun 1, and the needle gun 1 is provided with a gun shell 11, a trigger A 12, a firing assembly 13, and a trigger mechanism B 14. The gun shell 11 is provided with a shell-type needle outlet channel 111 and a mounting cavity 112. The shell-type needle outlet channel 111 has one end extending through the front surface of the gun shell 11 and the other end in communication with the mounting cavity 112. The firing assembly 13 is disposed within the mounting cavity 112 and comprises a first spring 131 which serving as the energy storage mechanism, a firing bar 132 and a firing sleeve 133 which together constitute the energy-increasing mechanism. The firing sleeve 133 is fixedly mounted on the gun shell 11 and is provided with a sliding slot 1330 extending in the front-to-rear direction, the sliding slot 1330 is positioned directly behind the shell-type needle outlet channel 111, and the firing bar 132 is slidably connected in the sliding slot 1330 of the firing sleeve 133. The trigger A 12 is positioned on the gun shell 11. The trigger mechanism B 14 is disposed in the mounting cavity 112 and comprises a trigger member 141 and a transmission mechanism 142. The trigger A 12 is connected to the power input of the transmission mechanism 142. The trigger member 141 comprises a push portion 1411 and a transmission portion 1412 connected with each other. The push portion 1411 is slidably connected in the sliding slot 1330 of the firing sleeve 133 and is positioned behind the firing bar 132. The transmission portion 1412 is located outside the firing sleeve 133. The first spring 131 is disposed in the sliding slot 1330 and is positioned between the firing bar 132 and the trigger member 141. The transmission portion 1412 is connected with the power output of the transmission mechanism 142 in a clutchable manner. The trigger A 12 is switchable between the reset state and the firing state. When the trigger A 12 is in the reset state, the transmission portion 1412 and the power output of the transmission mechanism 142 are clutched, and the first spring 131 is in a compressed state. When the trigger A 12 is in the firing state, the transmission portion 1412 and the power output of the transmission mechanism 142 are declutched, and the first spring 131 is released from the compressed state to the natural state.

Based on the said technical solution, the trigger A 12 can be switched between the reset state in which the transmission portion 1412 is engaged with the power output of the transmission mechanism 142 such that the first spring 131 is in the compressed state, and the firing state in which the transmission portion 1412 is disengaged from the power output of the transmission mechanism 142 such that the first spring 131 is released from the compressed state to the natural state. The elastic force instantaneously released by the first spring 131 can strike and eject the firing bar 132 disposed in the sliding slot 1330, thereby enabling the firing bar 132 to eject the needle through the shell-type needle outlet channel 111, to achieve acupuncture. After the firing is completed, the trigger A 12 is rotated and is switched back to the reset state, in which the transmission portion 1412 is engaged with the power output of the transmission mechanism 142 and the first spring 131 is compressed, in preparation for the next firing action. Consequently, due to the trigger A 12 switched between the reset state and the firing state, users can achieve resetting and firing through the trigger, thereby enhancing acupuncture efficiency and facilitating continuous firing. Hence, it facilitates promotion and use.

Preferably, referring to FIGS. 1-5, the shell-type needle outlet channel 111 may comprise an outlet portion 1111 and an alignment section 1112 that are sequentially arranged and communicated with each other. The outlet portion 1111 may be positioned at the front and has a smaller diameter than the alignment section 1112. Due to the alignment section 1112 with a relatively large diameter, the needles can be smoothly pushed into the shell-type needle outlet channel 111. Then, due to the outlet portion 1111 with a relatively small diameter, the needles can be guided and ejected from the gun shell 11. In this way, it ensures that the needles can stably penetrate the patient's body and achieve a better acupuncture effect.

Preferably, referring to FIGS. 1-5, the diameter of the outlet portion 1111 in the embodiment of the disclosure may be constant, and the diameter of the alignment section 1112 may gradually decrease from the rear to the front, with the diameter at its front end being the same as that of the outlet portion 1111. In this way, it provides better guidance for the needles into the outlet portion 1111 and facilitates a smooth ejection to enable the insertion of the acupuncture device.

Furthermore, referring to FIGS. 1-4 and 8, the transmission mechanism 142 comprises a driving gear 1421 and a driving member 1422. The driving gear 1421 and the driving member 1422 are rotatably connected within the mounting cavity 112. The trigger A 12 is mounted on the driving gear 1421 to drive the rotation of the driving gear 1421. The driving member 1422 comprises a disc-shaped body 14221. An meshed portion 14222 and a release portion 14223 are circumferentially arranged in sequence along the outer periphery of the body 14221. The meshed portion 14222 is defined with gear teethes provided on the outer peripheral surface of the body 14221, and the release portion 14223 is defined with a smooth surface provided on the outer peripheral surface of the body 14221. The transmission portion 1412 is provided with a rack 14121 extending in the front-to-rear direction. The meshed portion 14222 can be meshed with the driving gear 1421. When the rack 14121 is engaged with the meshed portion 14222, the trigger member 141 is engaged with the transmission mechanism 142. When the rack 14121 comes into contact with the release portion 14223, the trigger member 141 is disengaged from the transmission mechanism 142. Consequently, when the rack 14121 comes into contact with the release portion 14223, the trigger member 141 is disengaged from the transmission mechanism 142 such that the first spring 131 is no longer subjected to any external force and will be released from its compressed state to its natural state, thereby enabling the firing action. Conversely, when the rack 14121 is engaged with the meshed portion 14222, the trigger member 141 is combined with the transmission mechanism 142 such that the firing bar 132 is pulled backward by the trigger member 141, thereby compressing the first spring 131 to achieve resetting and preparing for the next firing.

Preferably, referring to FIGS. 1-4, to achieve the driving of the driving gear 1421 by the trigger A 12, the trigger mechanism B 14 may further comprise a first connecting rod 143 and a second connecting rod 144. Both the driving gear 1421 and the upper end of the trigger A 12 are rotatably connected to the mounting cavity 112 via the first connecting rod 143, and the upper end of the trigger A 12 is additionally fixedly connected to the driving gear 1421 via the second connecting rod 144, such that the rotation of the trigger A 12 can drive the rotation of the driving gear 1421, thereby achieving the driving of the driving gear 1421 by the trigger A 12.

Furthermore, referring to FIGS. 1-4 and 7, to enhance the safety of the needle gun 1 and prevent accidental needle discharge due to unintended activation of the trigger A 12, the needle gun 1 is further provided with a locking assembly 15. The locking assembly 15 is disposed within the mounting cavity 112 and is arranged behind the firing sleeve 133 at an interval. The locking assembly 15 comprises a locking member 151 and a second spring 152, with the locking member 151 being connected to the gun shell 11 via the second spring 152. The rear end of the trigger member 141 has a locking position 1413. When the trigger A 12 is in the reset state, the locking member 151 is cooperated and connected with the locking position 1413 to lock the trigger member 141. Due to the connection between the trigger member 141 and the locking member 151, the first spring 131 which is in the compressed state would not be released to its natural state even when the trigger A 12 rotates. Thus, it can ensure the safety of the acupuncture device 100.

Furthermore, referring to FIGS. 1-4 and 7, to achieve the cooperation and connection between the locking member 151 and the locking position 1413, the locking position 1413 is formed as a stop that protrudes downward and is arranged at the rear end of the trigger member. The front side surface of the stop engages with the rear surface of the locking member 151, thereby achieving the cooperation and connection between the locking member 151 and the stop.

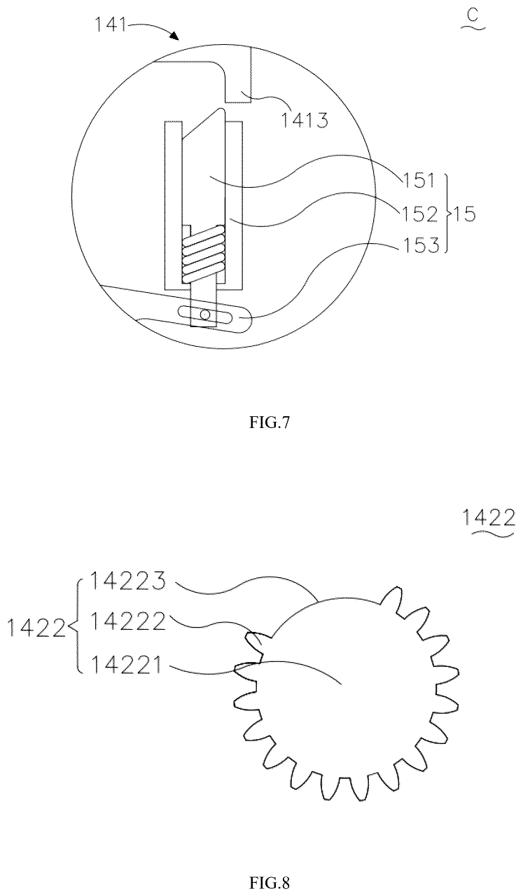

Furthermore, referring to FIG. 7, to reduce the resistance to the rear end of the locking position 1413 as it passes over the locking member 151, the upper end of the locking member is designed to have an inclined surface that gradually inclines upward from front to back.

Furthermore, referring to FIGS. 1-4 and 7, to facilitate disconnection between the locking member 151 and the locking position 1413 by a user, the locking assembly 15 further comprises an unlocking member 153 mounted on the gun shell 11 and connected to the locking member 151.

Furthermore, referring to FIGS. 1-4, The return spring 161 is connected between the trigger A 12 and the gun shell 11. When the trigger A 12 is in the reset state, the return spring 161 The return spring is in the natural state. When the trigger A 12 is in the firing state, The return spring 161 is in a compressed or stretched state. The return spring 161 allows the user to easily pull the trigger A 12 to switch between the reset state and the firing state.

Furthermore, referring to FIGS. 1-4, to facilitate the mounting of The return spring 161, the gun shell 11 is provided with a guide slot 162. The trigger A 12 has a guiding portion 121 that is slidably disposed in the guide slot 162, and The return spring 161 is positioned in the guide slot 162.

Preferably, referring to FIGS. 1-4, the guide slot 162 may be generally arc-shaped and concentric with the driving gear 1421, to facilitate the compression and rebound of The return spring 161 in the guide slot 162.

Furthermore, referring to FIGS. 1-4, to adjust the needle insertion depth, a restriction portion 134 for cooperating with the firing bar 132 to achieve position limitation is disposed in the firing sleeve 133. By moving the restriction portion 134 in the front-to-rear direction, the maximum forward position of the firing bar 132 can be limited, thereby enabling control over the needle insertion depth.

Preferably, referring to FIGS. 1-4, to realize the particular control of the needle insertion depth by the restriction portion 134, the firing assembly 13 may further comprise the restriction portion 134, which is slidably mounted at the front portion of the firing sleeve 133 and defines the limiting channel 1341 through which the firing bar 132 can pass. The firing bar 132 may comprise a firing portion 1321 and a restriction portion 1322 that are connected in sequence, with the firing portion 1321 being positioned at the front end. The firing bar 132 passes through the restriction portion 134, and the restriction portion 1322 has a diameter greater than that of the limiting channel 1341, enabling the restriction portion 134 to prevent the firing bar 132 from moving further forward. Consequently, by adjusting the position of the restriction portion 134 in the firing sleeve 133, the maximum forward distance that the firing bar 132 can move changes, which in turn changes the needle insertion depth during needle insertion of the acupuncture device 100, thereby achieving adjustable needle insertion depth.

Furthermore, referring to FIGS. 1-4 and 6, to adjust the elastic force of the first spring 131, the firing sleeve 133 may preferably comprise an inner sleeve 1331 and an outer sleeve 1332 slidably connected to the inner sleeve 1331. The inner sleeve 1331 may be provided with an inner channel 13311, the outer sleeve 1332 may be provided inside with a sleeve cavity 13321, at the front end with a the first opening 13322, and at the rear end with a the second opening 13323, wherein the first opening 13322 and the second opening 13323 are in communication with the sleeve cavity 13321. An extension portion 13324 extending forward defines the edge of the second opening 13323. The rear end of the inner sleeve 1331 is positioned within the sleeve cavity 13321 and is sleeved over the outer periphery of the extension portion 13324. The inner channel 13311 and the extension portion 13324 together define the sliding slot 1330. The first spring 132 is connected to the extension portion 13324. Consequently, as the position of the extension portion 13324 within the mounting cavity 112 changes, the compression amount of the first spring 132 during compression by the trigger mechanism B 14 can be changed, thereby enabling adjustment of the elastic force exerted by the first spring 131 when it returns.

Furthermore, referring to FIGS. 1-4, to facilitate the insertion of needles into the needle gun 1, the acupuncture device 100 further comprises a needle storage portion 2. The needle storage portion 2 is detachably connected in the mounting cavity 112 and is provided with a needle-ejection channel that is positioned between the shell-type needle outlet channel 111 and the firing sleeve 133.

Preferably, referring to FIG. 9, the needle storage portion 2 comprises a housing (not shown in the drawings), a box body 21, and an adjustment gear 212. The needle-ejection channel is positioned at the bottom end of the housing. The box body 21 is movably connected to the housing and is provided with a plurality of needle-storage cavities 211 that are evenly spaced and serve to accommodate needles. The adjustment gear 212 is rotatably connected to the gun shell 1 and serves to drive the box body 21 to move, so as to align the needle-storage cavities 211 with the needle-ejection channel and allow the needles to be ejected from the needle-storage cavities 211.

The working process of the disclosure is as follows.

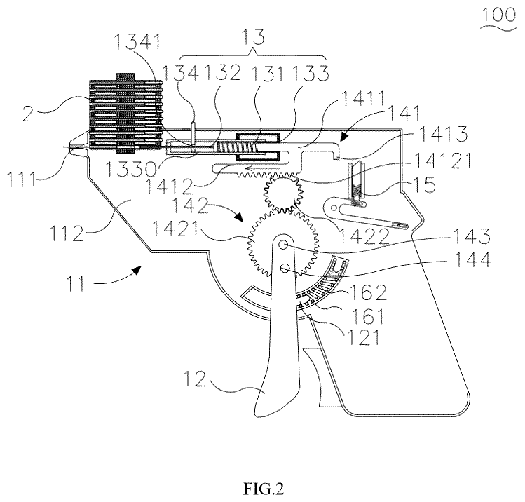

Referring to FIGS. 1-2, the unlocking member 153 can be pulled to drive the locking member 151 to move downward, thereby releasing the engagement between the locking member 151 and the locking position 1413. Then the trigger A 12 can be pulled to rotate (in the counterclockwise direction as shown in FIGS. 1-2) to drive the driving gear 1421 to rotate in the same direction and drive the driving member 1422 to rotate in the opposite direction. Until the rack 14121 comes into contact with the release portion 14223, the first spring 131 is released to the natural state, thereby enabling the firing bar 132 to move forward, push the needle located in the needle-ejection channel, and eject it from the shell-type needle outlet channel 111.

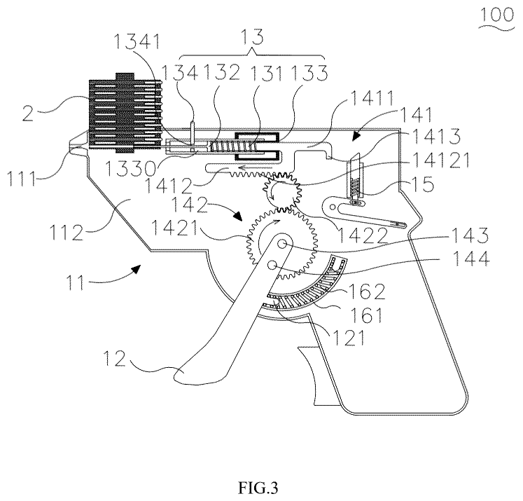

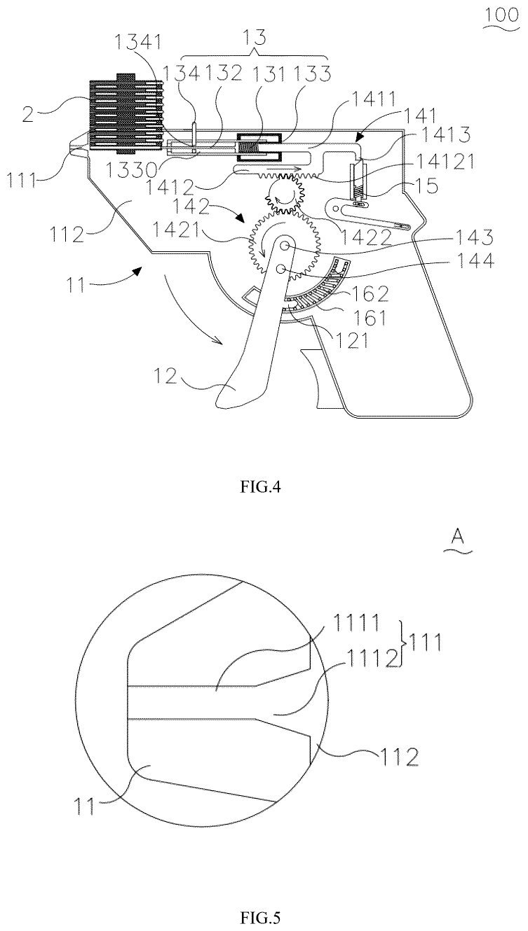

Referring to FIGS. 3-4, after ejection of the needle, the trigger can be first oppositely rotated (in the clockwise direction as shown in FIG. 3), and then pulled (in the counterclockwise direction as shown in FIG. 4) to drive the driving gear 1421 to rotate in the same direction and drive the driving member 1422 to rotate in the opposite direction. Until the rack 14121 connects with the meshed portion 14222, the trigger member 141 can be driven to move rearward, and the firing bar 132 can be driven to compress the first spring 131 to switch to the reset state. During the rearward movement of the trigger member 141, the stop first contacts the inclined surface at the upper end of the locking member 151, then presses the locking member 151 downward, and finally passes over the locking member 151. After that, the rear side of the locking member 151 can engage with the stop, thereby achieving locking.

In summary, an embodiment of the disclosure provides an acupuncture device which comprises the needle gun 1 and the needle storage portion 2. The needle gun 1 comprises the gun shell 11, the trigger A 12, the firing assembly 13, and the trigger mechanism B 14. When the trigger A 12 is in the firing state, the transmission portion 1412 is disengaged from the power output of the transmission mechanism 142. The first spring 131 is released from the compressed state to the natural state, thereby ejecting the firing bar 132 disposed in the sliding slot 1330 of the firing sleeve 133 through the elastic force instantaneously released by the first spring 131. Consequently, the needle can be ejected from the shell-type needle outlet channel 111 by the firing bar 132, thereby achieving acupuncture. After the firing is completed, the trigger A 12 can be rotated to engage the transmission portion 1412 with the power output of the transmission mechanism 142, thereby placing the first spring 131 in the compressed state, switching to the reset state, and awaiting the next firing action. Accordingly, by switching the trigger A 12 between the reset state and the firing state, the user can achieve resetting and firing by means of the trigger, thereby improving acupuncture efficiency and facilitating continuous firing. Hence, it facilitates promotion and use. As the needle storage portion 2 is detachably connected in the mounting cavity 112, it is easy to place needles in the needle gun 1 and enhance the firing efficiency of the acupuncture device 100.

### Embodiment 2

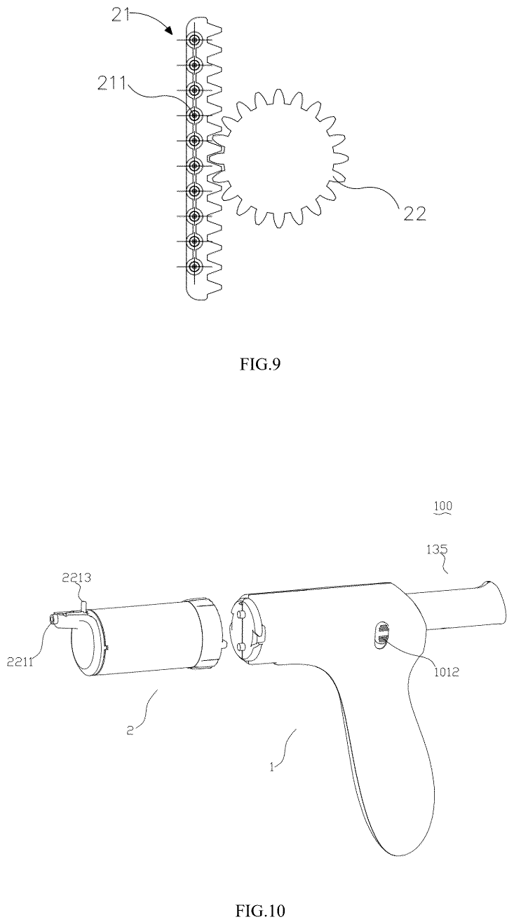

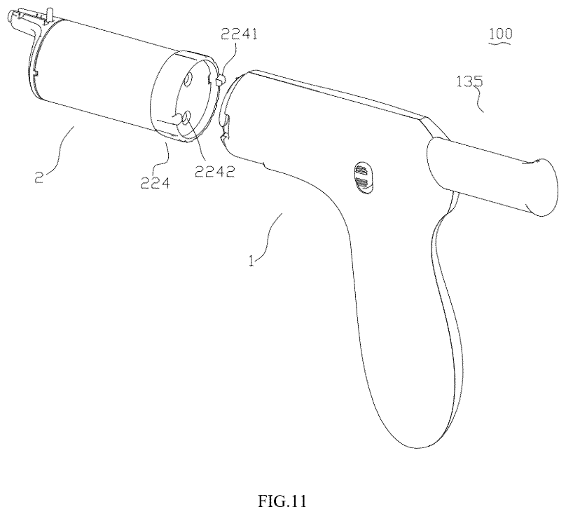

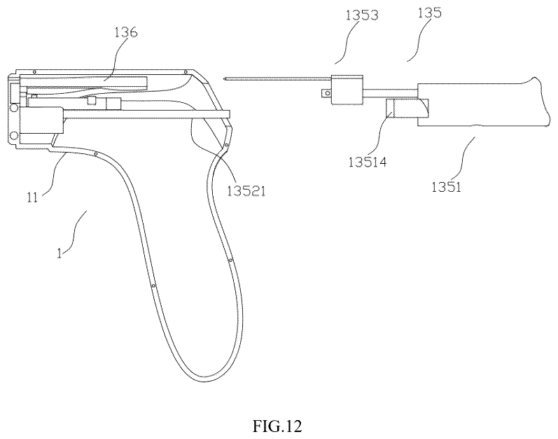

As shown in FIGS. 10-12, an acupuncture device 100 is provided with a needle gun 1 and a needle storage portion 2 for storing needles 3, wherein the needle storage portion 2 is assembled with the needle gun 1. The needle gun 1 is provided with a gun shell 11 and a firing assembly 13 for firing needles in the needle storage portion 2 outwards, and the firing assembly 13 is assembled with the gun shell 11.

The firing assembly 13 generates an outward impact force, and when the impact force acts on a current needle 3 inside the needle storage portion 2, the current needle 3 is separated from the needle storage portion 2 and is fired outwards.

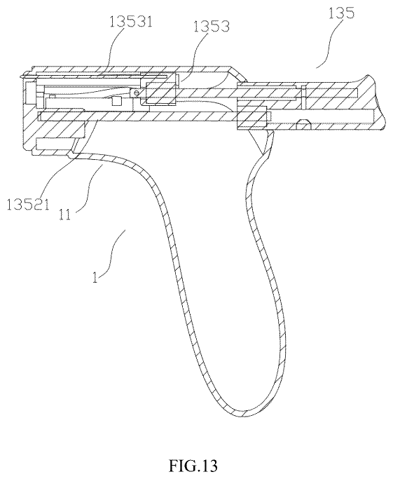

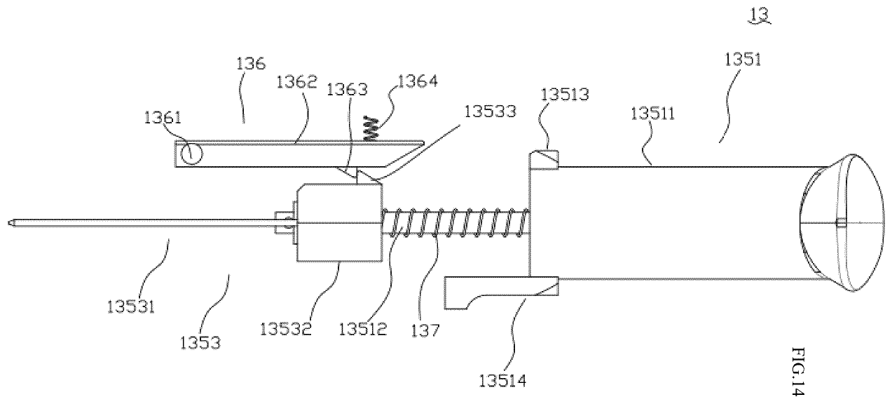

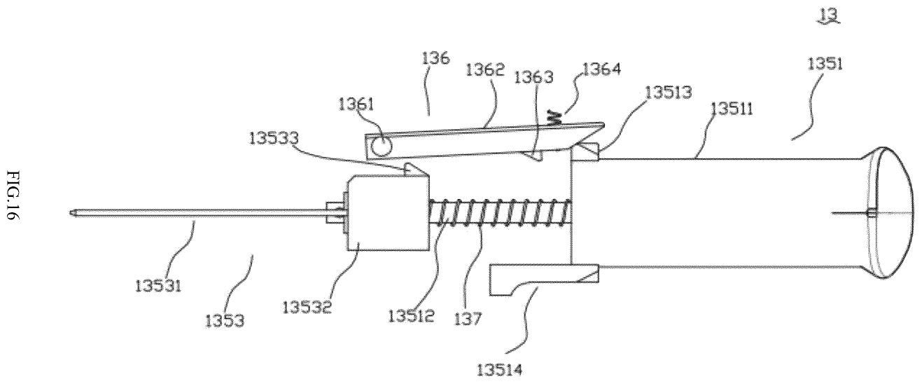

As shown in FIGS. 13-16, the firing assembly 13 is provided with an energy storage mechanism 137 for forming an impact force on the current needle 3, a trigger mechanism for generating a force on the energy storage mechanism 137, and an energy-increasing mechanism 136 for increasing the force of the energy storage mechanism 137. Both the energy storage mechanism 137 and the energy-increasing mechanism 136 are located inside the gun shell 11, the trigger mechanism is in transmission connection with the energy-increasing mechanism 136, and the energy-increasing mechanism 136 is movably connected to the energy storage mechanism 137. The energy storage mechanism 137 is a spring or an elastic member.

It is worth mentioning that the energy storage mechanism 137 is an object that is deformed under the action of an external force, is restored to its original state after the external force disappears, and stores or releases energy. The elastic member of the present invention may be an elastic metal sheet, an elastic fiber, a corrugated pipe, and a coil spring, etc. In this embodiment, the energy storage mechanism 137 is described by taking a spring as an example.

When the current needle 3 needs to be fired outwards, the force generated by the trigger mechanism is transmitted to the energy storage mechanism 137. At this point, the movement of the energy storage mechanism 137 is limited by the energy-increasing mechanism 136, and the trigger mechanism acts continuously such that the energy storage mechanism 137 further stores energy.

When the energy storage mechanism 137 is no longer limited, the energy of the energy storage mechanism 137 is released, so that the current needle 3 is separated from the needle storage portion 2 and is fired outwards.

It is worth mentioning that the needle storage portion 2 of the present invention is a disposable component that pre-stores a plurality of needles 3.

The trigger mechanism is defined as the trigger mechanism A 135. The trigger mechanism A 135 is provided with an ejector pin portion 1353 for impacting the current needle 3 and an impact source mechanism (not shown). The ejector pin portion 1353 is movably sleeved on a front end of the impact source mechanism, and the energy storage mechanism 137 is located between the ejector pin portion 1353 and the impact source mechanism. The energy-increasing mechanism 136 is rotatably connected in the interior of the gun shell 11.

When firing the current needle 3, the impact source mechanism is propelled to move forwards, and the impact source mechanism further propels the ejector pin portion 1353 to move forwards until the ejector pin portion 1353 is clamped with the energy-increasing mechanism 136. The impact source mechanism continues to push forwards, and at this point, the ejector pin portion 1353 is clamped and fixed to compress the energy storage mechanism 137. When the impact source mechanism continues to push until abutting against the energy-increasing mechanism 136, the energy-increasing mechanism 136 rotates and releases the ejector pin portion 1353. Under the resilience action of the energy storage mechanism 137, the ejector pin portion 1353 pops out from the front end of the gun shell 11 and impacts the current needle 3, so that the current needle 3 is fired outwards from the needle storage portion

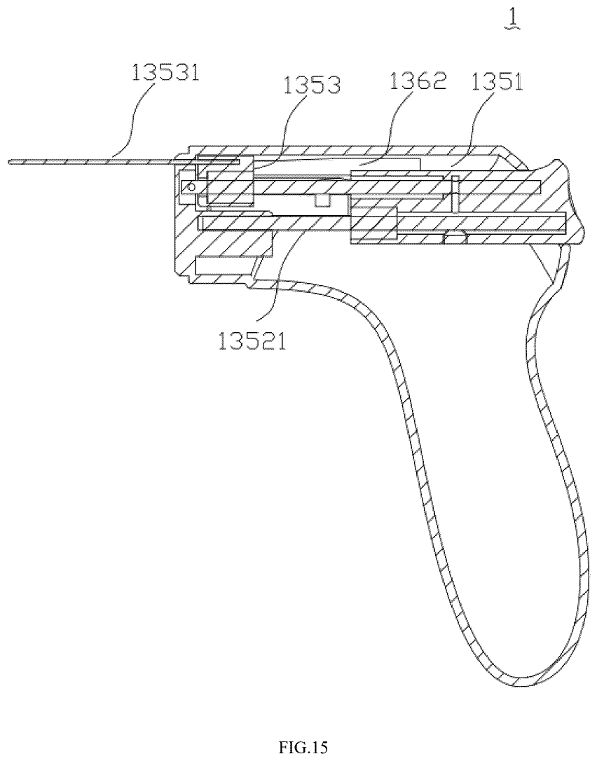

As shown in FIGS. 14-16, the energy-increasing mechanism 136 is provided with a rotating shaft 1361, a clamping platform 1362, a clamping block A 1363 and a first return spring 1364. The rotating shaft 1361 is fixed on an inner surface of the gun shell 11, one end of the clamping platform 1362 is rotatably sleeved with the rotating shaft 1361, and the other end of the clamping platform 1362 is movably abutted against a top block of the impact source mechanism. The clamping block A 1363 is integrally connected to the other end of the clamping platform 1362, two end surfaces of the first return spring 1364 respectively abut against the inner surface of the clamping platform 1362 and the gun shell 11, and the clamping block A 1363 is clamped with the ejector pin portion 1353 of the impact source mechanism.

It is worth mentioning that the energy-increasing mechanism 136 is used for preventing the ejector pin portion 1353 from moving forward when an excitation push rod 1351 is in the intermediate stage of pushing forward, thereby compressing the energy storage mechanism 137. When the excitation push rod 1351 is in the final stage of pushing forward, the top block of the impact source mechanism makes the energy-increasing mechanism 136 rotate, and the energy-increasing mechanism 136 releases the ejector pin portion 1353. At this point, the elastic force of the energy storage mechanism 137 is released, which allows the ejector pin portion 1353 to quickly move forward such that an impact force is imposed on the current needle 3.

Moreover, the top block of the clamping block A 1363 and the impact source mechanism are both configured to be right-triangle-shaped, and the hypotenuses of the two right triangles are opposite to each other, so that a push rod portion enables the ejector pin portion 1353 to smoothly slide through the clamping block A 1363.

In this embodiment, the impact source mechanism is a mechanical impact source mechanism. The mechanical impact source mechanism comprises the excitation push rod 1351 and the push rod portion (not shown) used for resetting the excitation push rod 1351. The excitation push rod 1351 movably abuts against the energy-increasing mechanism 136, the push rod portion is fixedly connected to the interior of the gun shell 11, and one end of the push rod portion abuts against the excitation push rod 1351. The ejector pin portion 1353 is movably sleeved on a front end of the excitation push rod 1351, and the energy storage mechanism 137 is located between the ejector pin portion 1353 and the excitation push rod 1351. In addition, two end surfaces of the energy storage mechanism 137 respectively abut against the ejector pin portion 1353 and the excitation push rod 1351. A front end of the ejector pin portion 1353 moves through the needle storage portion 2, and the ejector pin portion 1353 is movably clamped with the energy-increasing mechanism 136.

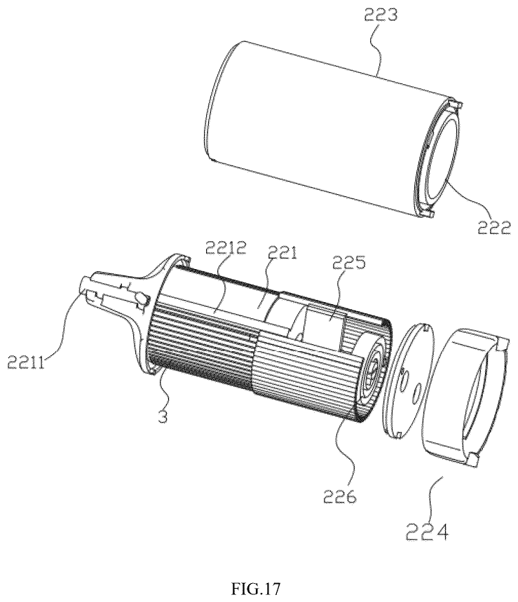

As shown in FIG. 14, when the current needle 3 needs to be fired outward, the excitation push rod 1351 is propelled to move forward, and the excitation push rod 1351 propels the ejector pin portion 1353 to move forward until the ejector pin portion 1353 is clamped with the energy-increasing mechanism 136. The excitation push rod 1351 continues to push forward, and at this point, the ejector pin portion 1353 is clamped and fixed to compress the energy storage mechanism 137. As shown in FIG. 16, when the excitation push rod 1351 continues to push until abutting against the energy-increasing mechanism 136, the energy-increasing mechanism 136 rotates and releases the ejector pin portion 1353. Under the resilience action of the energy storage mechanism 137, the ejector pin portion 1353 pops out from the front end of the gun shell 11 and impacts the current needle 3, so that the current needle 3 is fired outwards from the needle storage portion 2.

The excitation push rod 1351 is provided with a push rod main body 13511, a first sleeve rod 13512 and a top block A 13513 for making the energy-increasing mechanism 136 rotate. The push rod main body 13511 movably penetrates through the gun shell 11, and the first sleeve rod 13512 is fixedly connected to a front end surface of the push rod main body 13511. The ejector pin portion 1353 is movably sleeved on an outer surface of the first sleeve rod 13512, the energy storage mechanism 137 is sleeved on the outer surface of the first sleeve rod 13512, the top block A 13513 is connected to a front end of the push rod body 13511, and the top block A 13513 movably abuts against the energy-increasing mechanism 136.

It is worth mentioning that the excitation push rod 1351 of the present invention further comprises a locking member 13514, and the locking member 13514 interacts with a locking button 1012 of the gun shell 11. When the needle is no longer needed, the locking button 1012 is clamped into the locking member 13514 by means of the rotation of the locking button 1012, so that the excitation push rod 1351 is locked. In this way, the safety of the device is significantly improved.

As shown in FIGS. 14 and 16, the ejector pin portion 1353 comprises an ejector pin 13531, a needle seat 13532 and a clamping block B 13533. The ejector pin 13531 is fixedly connected to a front end surface of the needle seat 13532, the clamping block B 13533 is integrally connected to a front end of the needle seat 13532, and the clamping block B 13533 is movably clamped with the energy-increasing mechanism 136. The push rod portion further comprises a second sleeve rod 13521 and a thrust spring (not shown). The second sleeve rod 13521 is fixedly assembled inside the gun shell 11, the thrust spring is sleeved on an outer surface of the second sleeve rod 13521, and two ends of the thrust spring respectively abut against the push rod body 13511 and an inner wall of the gun shell 11.

When the current needle 3 needs to be fired, the excitation push rod 1351 is propelled to move forward to compress the thrust spring. After the current needle 3 is fired outward, the pushing force of the excitation push rod 1351 disappears, and under the action of the resilience force of the thrust spring, the excitation push rod 1351 and the ejector pin portion 1353 are propelled to reset.

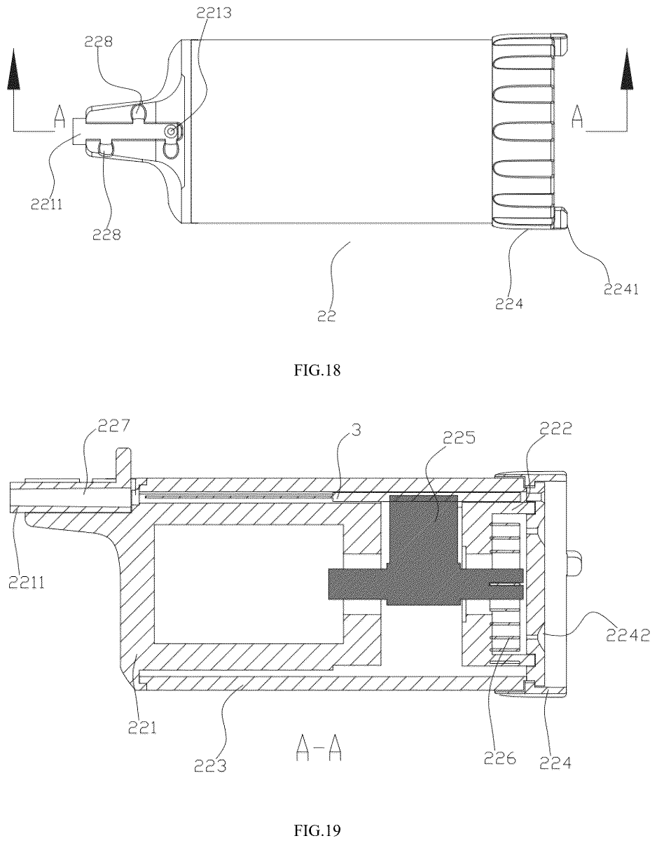

As shown in FIGS. 17-19, the needle storage portion 2 is configured to be a needle cylinder 22, and the needle cylinder 22 is detachably assembled at the front end of the gun shell 11. The needle cylinder 22 comprises a main cylinder body 221, an inner cylinder body 222, an outer cylinder body 223, an end cover 224, a pressing plate 225 and a toggle spring 226. The inner cylinder body 222 is located at a rear end of the main cylinder body 221, and the outer cylinder body 223 is sleeved outside the main cylinder body 221 and the inner cylinder body 222. An annular needle slot for storing needles 3 is formed between the outer cylinder body 223 as well as the main cylinder body 221 and the inner cylinder body 222. A front end of the outer cylinder body 223 abuts against a front end of the main cylinder body 221, and a rear end of the outer cylinder body 223 is clamped with the end cover 224. The pressing plate 225 and the toggle spring 226 are both assembled inside the inner cylinder body 222, and the pressing plate 225 is in transmission connection with the toggle spring 226. The pressing plate 225 is further connected to the main cylinder body 221 through a shaft, and a working end of the pressing plate 225 abuts against the needle in the annular needle slot.

The elastic force of the toggle spring 226 allows the working end of the pressing plate 225 to generate a pressing force, thereby making the needle rotate along the annular needle slot towards the position of a cylindrical needle outlet channel 227 of the main cylinder body 221. The main cylinder body 221 is provided with a needle outlet pipe 2211 and a positioning rod 2212 for blocking the needle 3. The needle outlet pipe 2211 is movably assembled inside the cylindrical needle outlet channel 227. The positioning rod 2212 is integrally connected to the annular needle slot and is located on a side wall of the cylindrical needle outlet channel 227.

It is worth mentioning that the toggle spring 226 of the present invention may be a constant force spring, a spiral spring or a clockwork spring, etc. In this embodiment, the clockwork spring is taken as an example for description. The toggle spring 226 of the present invention is used for making the pressing plate 225 rotate and always making the needle 3 in the annular needle slot face a positioning groove 2242. After the current needle 3 is fired outward, the toggle spring 226 propels the pressing plate 225 to rotate. In this way, another needle 3 is pushed towards the cylindrical needle outlet channel 227, thereby realizing the automatic loading of the needle 3.

The cylindrical needle outlet channel 227 is provided with a plurality of clamping holes 228, an outer surface of the needle outlet pipe 2211 is integrally connected to a clamping column 2213, and the clamping column 2213 and the clamping holes 228 are detachably connected.

It is worth mentioning that, the clamping holes 228 are located at different positions of the cylindrical needle outlet channel 227, and the clamping holes 228 at different positions are correspondingly selected according to the actual acupuncture depth, thereby controlling the extension length of the needle outlet pipe 2211. The width of the annular needle slot is equal to or slightly greater than the outer diameter of the needle, and the inner diameter of the needle outlet pipe 2211 needs to be greater than the diameter of the needle 3 but does not affect the movement of the needle. The principle of controlling the acupuncture depth of the needle outlet pipe 2211 is as follows: because the end portion of the needle outlet pipe 2211 abuts against a patient's skin, the distance of the needle relative to the patient's skin is adjusted by inserting the clamping column 2213 into different clamping holes 228, thereby adjusting the penetration depth of the needle.

The needle cylinder 22 of the present invention is directly assembled to the needle gun 1 and is substantially flush with the edge of the needle gun 1, so that the operator's sight is not blocked, and the accuracy of the acupuncture position is improved. Moreover, in the present invention, by means of replacing the needle cylinders 22 with different lengths, needles with different lengths become compatible. The continuous firing acupuncture gun in the present invention has a simple structure, and the needle cylinder 22 is simple and convenient to replace. In addition, by using the annular needle slot, the number of the stored needles is increased.

The end cover 224 is provided with a clamping member 2241 and the positioning groove 2242, the clamping member 2241 is clamped in the clamping groove of the gun shell 11, and the positioning column of the gun shell 11 is inserted into the positioning groove 2242.

The operating principle of the acupuncture device 100 in this embodiment is as follows: the excitation push rod 1351 is pushed by an operator to move forward, and the excitation push rod 1351 propels the ejector pin portion 1353 to move forward until the ejector pin portion 1353 is clamped with the energy-increasing mechanism 136; the excitation push rod 1351 continues to push forward, and at this point, the position of the ejector pin portion 1353 does not change due to abutting against the energy-increasing mechanism 136, and the energy storage mechanism 137 is compressed; when the excitation push rod 1351 continues to push until abutting against the energy-increasing mechanism 136, the energy-increasing mechanism 136 rotates and releases the the ejector pin portion 1353; under the resilience force of the energy storage mechanism 137, the ejector pin portion 1353 pops out from the front end of the gun shell 11 to impact the current needle 3, so that the current needle 3 is fired outwards from the needle storage portion 2; meanwhile, under the action of the pressing plate 225, another needle 3 in the annular needle slot rotates in the direction of the positioning rod 2212, so that the current needle is replaced by a next needle 3 adjacent to the current needle 3; at this point, the pushing force of the excitation push rod 1351 disappears, and under the action of the elastic force of the thrust spring, the excitation push rod 1351 and the ejector pin portion 1353 are propelled to reset.

The firing assembly 13 enables the acupuncture device to switch between a reset state and a firing state, thereby allowing the operator to perform reset and firing through the firing assembly 13. In this way, the acupuncture efficiency is enhanced, the continuous firing is facilitated, and the use is promoted.

### Embodiment 3

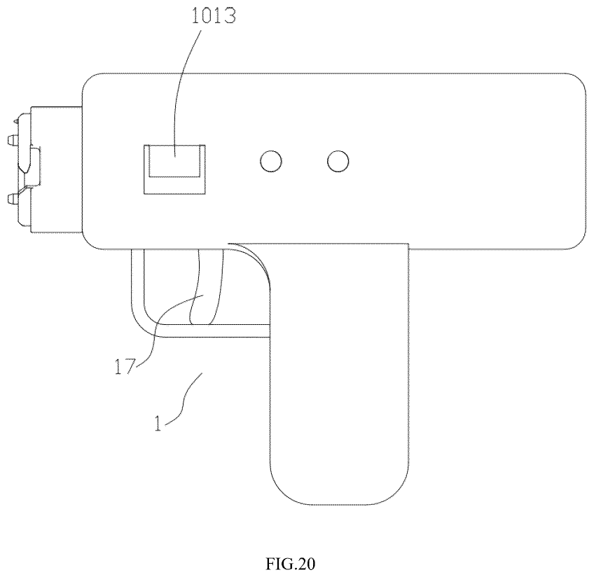

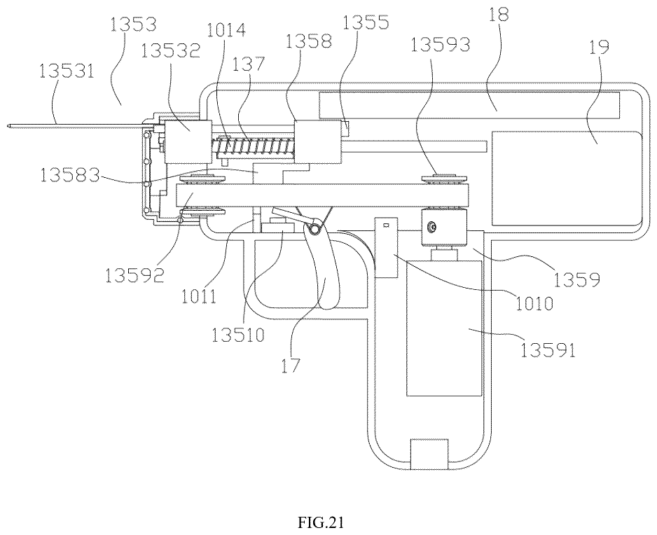

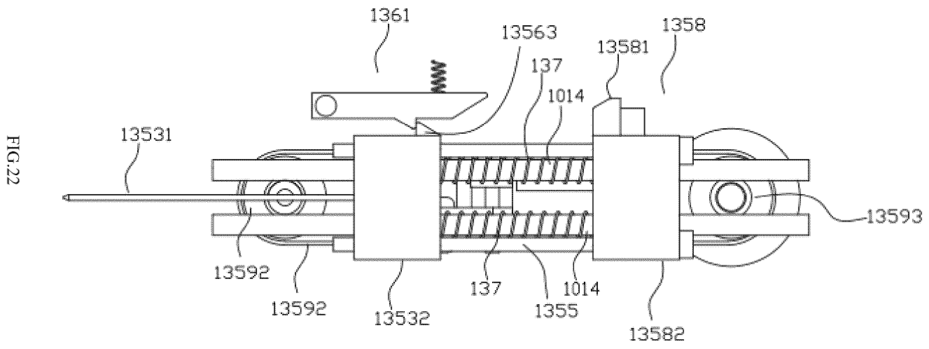

Referring to FIGS. 20-22, most of the features of the acupuncture device 100 in embodiment 2 are the same as those in Embodiment 1, except that the impact source mechanism in embodiment 2 is an electrically driven impact source mechanism.

The electrically driven impact source mechanism comprises a connecting member 1358 for propelling the ejector pin portion 1353 and the energy storage mechanism 137 to move back and forth, an electric drive portion 1359 for propelling the connecting member 1358 to move back and forth, a third sleeve rod 1014, a guide rod 1355, and an excitation button 13510. The connecting member 1358, the electric drive portion 1359 and the third sleeve rod 1014 are all located inside the gun shell 11. The connecting member 1358 movably abuts against the energy-increasing mechanism 136, the third sleeve rod 1014 is fixedly connected to a front end surface of the connecting member 1358, and the ejector pin portion 1353 is movably sleeved on a front end of the third sleeve rod 1014. The energy storage mechanism 137 is sleeved on the third sleeve rod 1014, and the energy storage mechanism 137 is located between the ejector pin portion 1353 and the connecting member 1358. Two end surfaces of the energy storage mechanism 137 respectively abut against the ejector pin portion 1353 and the connecting member 1358, the front end of the ejector pin portion 1353 movably penetrates through the needle storage portion 2, and the ejector pin portion 1353 is movably clamped with the energy-increasing mechanism 136. The guide rod 1355 and the excitation button 13510 are both located inside the gun shell 11, and the guide rod 1355 is fixedly connected to the interior of the gun shell 11. The connecting member 1358 and the ejector pin portion 1353 are both movably sleeved on the guide rod 1355, and the excitation button 13510 is electrically connected to the electric drive portion 1359.

When the current needle 3 is fired outward, the excitation button is pressed, and the electric drive portion 1359 propels the connecting member 1358 to move forward. At this point, the connecting member 1358 further propels the ejector pin portion 1353 to move forward until the ejector pin portion 1353 abuts against the energy-increasing mechanism 136. The connecting member 1358 continues to push forward, and at this point, the ejector pin portion 1353 is clamped and fixed to compress the energy storage mechanism 137. When the connecting member 1358 continues to push until abutting against the energy-increasing mechanism 136, the energy-increasing mechanism 136 rotates to release the ejector pin portion 1353. Under the action of the resilience force of the energy storage mechanism 137, the ejector pin portion 1353 pops out from the front end of the gun shell 11 and impacts the current needle 3, so that the current needle 3 is fired outward from the needle storage portion 2. After the current needle 3 is fired outward, the electric drive portion 1359 propels the connecting member 1358 to move backward, and the ejector pin portion 1353 returns to the initial position and is re-clamped with the energy-increasing mechanism 136 such that the reset is completed.

It is worth mentioning that the guide rod 1355 of the present invention is also capable of guiding the ejector pin 13531 when the ejector pin 13531 is actuated to pop out, thereby ensuring the movement accuracy of the ejector pin 13531.

The connecting member 1358 comprises a connecting base 13582, a mounting block 13583, and a top block B 13581 for making the energy-increasing mechanism 136 rotate. The connecting base 13582 is fixedly connected to the mounting block 13583, the third sleeve rod 1014 is fixedly connected to a front end surface of the connecting base 13582, and the connecting base 13582 is movably sleeved with the guide rod 1355. The mounting block 13583 is fixedly connected to the electric drive portion 1359, the top block B 13581 is integrally connected to a front end of the connecting base 13582, and the top block B 13581 movably abuts against the energy-increasing mechanism 136.

It is worth mentioning that the structure of the ejector pin portion 1353 in this embodiment is basically the same as that in Embodiment 1.

The electric drive portion 1359 comprises a motor 13591, a transmission belt 13592 and a pair of rotating wheels 13593. The motor 13591, the transmission belt 13592 and the rotating wheels 13593 are all arranged inside the gun shell 11. A shaft of the motor 13591 is in transmission connection with one of the rotating wheels 13593, the transmission belt 13592 is sleeved outside the two rotating wheels 13593, and the mounting block 13583 is fixedly connected to the transmission belt 13592.

The needle gun 1 further comprises a trigger B 17, a circuit board 18, a battery 19, a photoelectric sensor 1010 for detecting the position of the connecting member 1358, and a detection sheet 1011 for interacting with the photoelectric sensor 1010, wherein the trigger B 17 is rotatably assembled to the gun shell 11, and the trigger B 17 movably abuts against the excitation button 13510. The circuit board 18, the battery 19 and the photoelectric sensor 1010 are all located inside the gun shell 11, and the detection sheet 1011 is fixedly assembled on the connecting member 1358. The circuit board 18 and the motor 13591 are both electrically connected to the battery 19, and the circuit board 18 is further electrically connected to the excitation button 13510.

It is worth mentioning that the acupuncture device 100 in this embodiment is further provided with a counting display portion 1013 for displaying the number of the fired needles or displaying the number of remaining needles in the needle cylinder 22. The counting display portion 1013 is electrically connected to the circuit board 18. The circuit board 18, the photoelectric sensor 1010, the detection sheet 1011 and the counting display portion 1013 of the present invention are common electronic devices. Those skilled in the art should know their operating principles, connection methods and use methods, and therefore they are briefly described herein.

The operating principle of the acupuncture device 100 in this embodiment is as follows: when the operator pulls the trigger, the trigger triggers the excitation button 13510, and the motor 13591 propels the rotating wheels 13593 to rotate; at this point, the transmission belt 13592 is propelled to move along with the rotating wheels 13593, the connecting member 1358 moves forward, and the connecting member 1358 propels the ejector pin portion 1353 to move forward until the ejector pin portion 1353 is clamped with the energy-increasing mechanism 136; the connecting member 1358 continues to push forward, and at this point, the position of the ejector pin portion 1353 does not change due to abutting against the energy-increasing mechanism 136 and the energy storage mechanism 137 is compressed; when the connecting member 1358 continues to push until abutting against the energy-increasing mechanism 136, the energy-increasing mechanism 136 rotates and releases the ejector pin portion 1353; under the action of the resilience force of the energy storage mechanism 137, the ejector pin portion 1353 pops out from the front end of the gun shell 11 and impacts the current needle 3, so that the current needle 3 is fired outward from the needle storage portion 2; after the current needle 3 is fired outward, the motor 13591 reversely propels the transmission belt 13592, the rotating wheels 13593 rotate reversely, the connecting member 1358 moves backward, and the ejector pin portion 1353 is reset.

Compared with Embodiment 1, by means of the electrically driven impact source mechanism in embodiment 2, it is unnecessary to manually push the excitation push rod 1351 such that the push rod mechanism is simplified.

### Embodiment 4

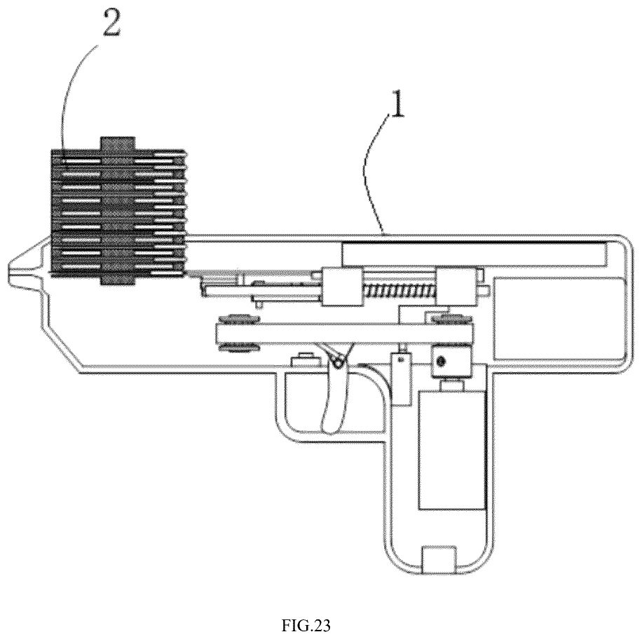

As shown in FIG. 23, other features of the acupuncture device 100 in embodiment 3 are the same as those in Embodiment 1 or 2 expect that the acupuncture device 100 in embodiment 3 adopts the electrically driven impact source mechanism in embodiment 2, the needle storage portion 2 is a needle box, the needle box is detachably connected to the interior of the gun shell 11, the needle box is provided with a box-type needle outlet channel, and the box-type needle outlet channel is located between the needle outlet and the firing assembly 13.

Preferably, as shown in FIG. 9, the needle storage portion 2 also comprises a housing (not shown), a box body 21 and an adjustment gear 212. A bottom end of the housing is provided with a needle outlet channel 227, the box body 21 is movably connected to the housing, and a plurality of needle storage cavities 211 for accommodating the needles 3 are uniformly formed at intervals in the box body 21. The adjustment gear 212 is rotatably connected to the gun shell 11, and the adjustment gear 212 is used for propelling the box body 21 to move so that the needle-storage cavities 211 is aligned with the box-type needle outlet channel, In this way, the needle 3 in the needle-storage cavities 211 is fired outward.

Compared with Embodiment 1, the structure of the needle box in this embodiment is simpler.

All the above are merely some preferred embodiments of the disclosure. It should be noted that those skilled in the art may obtain modifications and equivalents without departing from the technical principles of the disclosure. The disclosure is intended to cover such modifications and equivalents.

1. An acupuncture device, comprising:
a needle gun and a needle storage portion for storing needles, wherein the needle storage portion is assembled with the needle gun, wherein the needle gun further comprises: a gun shell and a firing assembly used for firing the needles in the needle storage portion outwards, wherein the firing assembly is assembled with the gun shell, wherein the firing assembly comprises:
an energy storage mechanism for forming an impact force on the current needle, a trigger mechanism for generating a force on the energy storage mechanism, and an energy-increasing mechanism for increasing the force of the energy storage mechanism, wherein both the energy storage mechanism and the energy-increasing mechanism are located inside the gun shell, wherein the trigger mechanism is in transmission connection with the energy-increasing mechanism, wherein the energy-increasing mechanism is movably connected to the energy storage mechanism, wherein when there is a need to fire the current needle, the force generated by the trigger mechanism is conducted to the energy storage mechanism, wherein at this point, under the limit of the energy-increasing mechanism, the motion of the energy storage mechanism is limited, wherein the trigger mechanism continues to make the energy storage mechanism store energy, and wherein after the energy storage mechanism is released, the energy of the energy storage mechanism is released, so that the current needle is fired outward from the needle storage portion.

2. The acupuncture device of claim 1, wherein the energy storage mechanism is a spring or an elastic member.

3. The acupuncture device of claim 2, wherein the needle gun comprises a gun shell, a trigger A, a firing assembly, and a trigger mechanism B;
the gun shell is provided with a shell-type needle outlet channel and a mounting cavity, and the shell-type needle outlet channel has one end extending through a front surface of the gun shell and another end in communication with the mounting cavity;
the firing assembly comprises a first spring which serving as the energy storage mechanism, as well as a firing bar and a firing sleeve which together constitute the energy-increasing mechanism, the firing sleeve is fixedly mounted on the gun shell and is provided with a sliding slot extending in a front-to-rear direction, the sliding slot is positioned directly behind the shell-type needle outlet channel, and the firing bar is slidably connected in the sliding slot of the firing sleeve;
the trigger A is provided on the gun shell; the trigger mechanism B is disposed in the mounting cavity and comprises a trigger member and a transmission mechanism; the trigger A is connected to a power input of the transmission mechanism; the trigger member comprises a push portion and a transmission portion connected with each other; the push portion is slidably connected in the sliding slot of the firing sleeve and is positioned behind the firing bar; the transmission portion is located outside the firing sleeve; the first spring is disposed in the sliding slot and positioned between the firing bar and the trigger member;
the transmission portion is connected with a power output of the transmission mechanism in a clutchable manner; and
the trigger A is switchable between a reset state and a firing state; in the reset state of the trigger A, the transmission portion and the power output of the transmission mechanism are clutched, and the first spring is in a compressed state; in the firing state of the trigger A, the transmission portion and the power output of the transmission mechanism are declutched, and the first spring is released from the compressed state to the natural state.

4. The acupuncture device according to claim 3, wherein the transmission mechanism comprises a driving gear and a driving member;
the driving gear and the driving member are rotatably connected in the mounting cavity, the trigger is mounted on the drive gear, to drive the driving gear to rotate;
the driving member comprises a body that is disc-shaped, an meshed portion and a release portion are circumferentially arranged in sequence along an outer periphery of the body, the meshed portion is defined with gear teethes provided on an outer peripheral surface of the body, and the release portion is defined with a smooth surface provided on the outer peripheral surface of the body;
the transmission portion is provided with a rack extending in the front-to-rear direction,
the meshed portion is meshed with the drive gear, such that the trigger member is engaged with the transmission mechanism in such a case that the rack is engaged with the meshed portion, and the trigger member is disengaged from the transmission mechanism in such a case that the rack comes into contact with the release portion.

5. The acupuncture device according to claim 3, wherein the needle gun further comprises a locking assembly;
the locking assembly is disposed in the mounting cavity and arranged behind the firing sleeve at an interval, the locking assembly comprises a locking member and a second spring, and the locking member is connected to the gun shell via the second spring;
the trigger member is provided at a rear end with a locking position, and the locking member is cooperated and connected with the locking position in the reset state of the trigger.

6. The acupuncture device according to claim 5, wherein the locking position is formed as a stop protruding downward and arranged at a rear end of the trigger member, and the stop has a front side surface that can engage a rear surface of the locking member to achieve cooperation and connection between the locking member and the stop, an upper end of the locking member has an inclined surface that gradually inclines upward from front to back..

7. The acupuncture device according to claim 6, wherein further comprising an unlocking member mounted on the gun shell and connected to the locking member.

8. The acupuncture device according to claim 3, wherein the return spring is connected between the trigger A and the gun shell, wherein, in the reset state of the trigger A, the return spring is in a natural state; and in the firing state of the trigger A, the return spring is in a compressed or stretched state.

9. The acupuncture device according to claim 8 wherein the gun shell is provided with a guide slot, the trigger A has a guiding portion that is slidably disposed in the guide slot, and the return spring is positioned in the guide slot. □
a restriction portion for cooperating with the firing bar to achieve position limitation is disposed in the firing sleeve.

10. The acupuncture device of claims 1, wherein the needle storage portion is a needle box, wherein the needle box is detachably connected to the interior of the gun shell, wherein the needle box is provided with a box-type needle outlet channel, and wherein the box-type needle outlet channel is located between the needle outlet and the firing assembly.

11. The acupuncture device of claim 2, wherein the energy-increasing mechanism comprises:
a rotating shaft, a clamping platform, a clamping block A and a first return spring, wherein the rotating shaft is fixed on an inner surface of the gun shell, wherein one end of the clamping platform is rotatably sleeved with the rotating shaft, wherein the other end of the clamping platform is movably abutted against a top block of the impact source mechanism, wherein the clamping block is integrally connected to the other end of the clamping platform, wherein two end surfaces of the first return spring respectively abut against the inner surface of the clamping platform and the gun shell, and wherein the clamping block A is clamped with the ejector pin portion of the impact source mechanism.

12. The acupuncture device of claim 2, wherein the trigger mechanism is defined as the trigger mechanism A, wherein the trigger mechanism A is provided with an ejector pin portion for impacting the current needle and an impact source mechanism, wherein the ejector pin portion is movably sleeved on a front end of the impact source mechanism, wherein the energy storage mechanism is located between the ejector pin portion and the impact source mechanism, wherein the energy-increasing mechanism is rotatably connected in the interior of the gun shell, wherein when firing the current needle, the impact source mechanism is propelled to move forwards, wherein the impact source mechanism further propels the ejector pin portion to move forwards until the ejector pin portion is clamped with the energy-increasing mechanism, wherein the impact source mechanism continues to push forwards, wherein at this point, the ejector pin portion is clamped and fixed to compress the energy storage mechanism, wherein when the impact source mechanism continues to push until abutting against the energy-increasing mechanism, wherein the energy-increasing mechanism rotates and releases the ejector pin portion, and wherein under the resilience action of the energy storage mechanism, the ejector pin portion pops out from the front end of the gun shell and impacts the current needle, so that the current needle is fired outwards from the needle storage portion.

13. The acupuncture device of claim 12, wherein the impact source mechanism is a mechanical impact source mechanism, wherein the mechanical impact source mechanism comprises:
an excitation push rod and a push rod portion used for resetting the excitation push rod, wherein the excitation push rod movably penetrates through the gun shell, wherein the excitation push rod movably abuts against the energy-increasing mechanism, wherein the excitation push rod movably abuts against the energy-increasing mechanism, wherein the push rod portion is fixedly connected to the interior of the gun shell, wherein one end of the push rod portion abuts against the excitation push rod, wherein the ejector pin portion is movably sleeved on a front end of the excitation push rod, wherein the energy storage mechanism is located between the ejector pin portion and the excitation push rod, wherein two end surfaces of the energy storage mechanism respectively abut against the ejector pin portion and the excitation push rod, wherein a front end of the ejector pin portion movably penetrates through the needle storage portion, and wherein the ejector pin portion is movably clamped with the energy-increasing mechanism.

14. The acupuncture device of claim 13, wherein the excitation push rod comprises:
a push rod main body, a first sleeve rod and a top block A for making the energy-increasing mechanism rotate, wherein the push rod main body movably penetrates through the gun shell, wherein the first sleeve rod is fixedly connected to a front end surface of the push rod main body, wherein the ejector pin portion is movably sleeved on an outer surface of the first sleeve rod, wherein the energy storage mechanism is sleeved on the outer surface of the first sleeve rod, wherein the top block A is connected to a front end of the push rod main body, and wherein the top block A movably abuts against the energy-increasing mechanism.

15. The acupuncture device of claim 14, wherein the push rod portion further comprises:
a second sleeve rod and a thrust spring, wherein the second sleeve rod is fixedly assembled inside the gun shell, wherein the thrust spring is sleeved on an outer surface of the second sleeve rod, wherein two ends of the thrust spring respectively abut against the push rod body and an inner wall of the gun shell, wherein when the current needle needs to be fired, the excitation push rod is propelled to move forward to compress the thrust spring, wherein after the firing is completed, the pushing force of the excitation push rod disappears, and wherein under the action of the resilience force of the thrust spring, the excitation push rod and the ejector pin portion are propelled to reset.

16. The acupuncture device of claim 12, wherein the impact source mechanism is an electrically driven impact source mechanism, wherein the electrically driven impact source mechanism comprises:
a connecting member for propelling the ejector pin portion and the energy storage mechanism to move back and forth, an electric drive portion for propelling the connecting member to move back and forth, and a third sleeve rod, wherein the connecting member, the electric drive portion and the third sleeve rod are all located inside the gun shell, wherein the connecting member movably abuts against the energy-increasing mechanism, wherein the third sleeve rod is fixedly connected to a front end surface of the connecting member, wherein the ejector pin portion is movably sleeved on a front end of the third sleeve rod, wherein the energy storage mechanism is sleeved on the third sleeve rod, wherein the energy storage mechanism is located between the ejector pin portion and the connecting member, wherein two end surfaces of the energy storage mechanism respectively abut against the ejector pin portion and the connecting member, wherein the front end of the ejector pin portion movably penetrates through the needle storage portion, and wherein the ejector pin portion is movably clamped with the energy-increasing mechanism.

17. The acupuncture device of claim 16, wherein the electrically driven impact source mechanism further comprises:
a guide rod, and an excitation button, wherein the guide rod and the excitation button are both located inside the gun shell, wherein the guide rod is fixedly connected to the interior of the gun shell, wherein the connecting member and the ejector pin portion are both movably sleeved on the guide rod, wherein the excitation button is electrically connected to the electric drive portion, wherein the connecting member comprises:
a connecting base, a mounting block, and a top block B for making the energy-increasing mechanism rotate, wherein the connecting base is fixedly connected to the mounting block, wherein the third sleeve rod is fixedly connected to a front end surface of the connecting base, wherein the connecting base is movably sleeved with the guide rod, wherein the mounting block is fixedly connected to the electric drive portion, wherein the top block B is integrally connected to a front end of the connecting base, wherein the top block B movably abuts against the energy-increasing mechanism, wherein the electric drive portion comprises:
a motor, a transmission belt and a pair of rotating wheels, wherein the motor, the transmission belt and the rotating wheels are all arranged inside the gun shell, wherein a shaft of the motor is in transmission connection with one of the rotating wheels, wherein the transmission belt is sleeved outside the two rotating wheels, and wherein the mounting block is fixedly connected to the transmission belt.

18. The acupuncture device of claims 17, wherein the ejector pin portion comprises: an ejector pin, a needle seat and a clamping block B, wherein the ejector pin is fixedly connected to a front end surface of the needle seat, wherein the clamping block B is integrally connected to a front end of the needle seat, and wherein the clamping block B is movably clamped with the energy-increasing mechanism.

19. The acupuncture device of claims 17, wherein the needle storage portion is a needle cylinder, wherein the needle cylinder is detachably assembled at the front end of the gun shell, wherein the needle cylinder comprises:
a main cylinder body, an inner cylinder body, an outer cylinder body, an end cover, a pressing plate and a toggle spring, wherein the inner cylinder body is located at a rear end of the main cylinder body, wherein the outer cylinder body is sleeved outside the main cylinder body and the inner cylinder body, wherein an annular needle slot for storing needles is formed between the outer cylinder body as well as the main cylinder body and the inner cylinder body, wherein a front end of the outer cylinder body abuts against a front end of the main cylinder body, wherein a rear end of the outer cylinder body is clamped with the end cover, wherein the pressing plate and the toggle spring are both assembled inside the inner cylinder body, wherein the pressing plate is in transmission connection with the toggle spring, wherein the pressing plate is further connected to the main cylinder body through a shaft, and a working end of the pressing plate abuts against the needle in the annular needle slot, and wherein the elastic force of the toggle spring allows the working end of the pressing plate to generate a pressing force, thereby making the needle rotate along the annular needle slot towards the position of a cylindrical needle outlet channel of the main cylinder body.
